(19) United States
(12) Patent Application Publication
(10) Pub. No.: US 2024/0330478 A1
(43) Pub. Date: Oct. 3, 2024

(54) ENUMERATION ATTACK PREDICTION

(71) Applicant: Acronis International GmbH, Schaffhausen (CH)

(72) Inventors: Vladimir Strogov, Singapore (SG); Valeriy Chernyakovskiy, Singapore (SG); Aliaksei Dodz, Singapore (SG); Vyacheslav Levchenko, Saint Petersburg (RU); Stanislav Protasov, Singapore (SG); Serg Bell, Singapore (SG)

(21) Appl. No.: 18/193,397

(22) Filed: Mar. 30, 2023

(51) Int. Cl. G06F 21/57; G06F 21/55; G06F 21/56

(52) U.S. Cl. CPC G06F 21/577; G06F 21/554; G06F 21/568

(57) ABSTRACT

Systems and methods to predict an enumeration-based attack. A System includes a security sensor configured to track one or more system events and determine a sequence of operations of processes executed in response to the one or more system events. In addition, the system includes a security agent having a prediction unit configured to analyze the tracked storage operations of each process to generate a first security verdict and determine if a first probabilistic value identifying probability of finding the enumeration attack exceeds a first threshold value for a particular process. The security agent also includes an analysis module configured to obtain a full stack corresponding to the particular process from the security sensor, conduct the full stack analyses of the particular process, to generate a second verdict, and characterize the process as malicious, if the probabilistic value of the second verdict exceeds a second threshold value.

### TECHNICAL FIELD

The present disclosure generally relates to threat analysis. In particular, the present disclosure relates to protecting data stored in a computing environment against a malicious enumeration-based attack.

### BACKGROUND

Malicious software, also referred to as “malware,” is software that can infiltrate or damage a computer system by corrupting software code, resulting in abnormal operation or even termination of applications and the operating system. Generally, malware infiltrates by performing an attack or a series of attacks in forms of information requests. For instance, an attack by malware can identify system parameters by sending requests with an enumerated parameter and analyzing the response. One example of such an attack performed by malware is password brute force. The main purpose of this technique is aimed at databases, web applications, asset directories, and network protocols, among other examples.

There are also other legitimate types of calls that malware uses to carry out a threat, such as deleting or encrypting system files. The calls also include file enumeration. There are various sets of request data parameters that can indicate the malicious nature of the request. Examples of such parameters include a file mask, a request frequency, a request to enumerate a large number of files or root folders, and sequential enumeration of folders according to a certain principle (for example, alphabetically).

Such tools and services require special security tools, other than techniques to protect against leaks of logins, passwords, and network configurations, which include response obfuscation, network request filtering, and application pen-testing.

Therefore, there is a need to detect malicious enumeration requests and protect computer systems from malicious applications using enumeration requests.

### SUMMARY

The present disclosure describes a method for predicting data threats based on suspicious enumeration requests. The method includes tracking, by a security sensor, one or more system events and determining a sequence of operations of processes executed associated with one or more system events. The method also includes monitoring, by the security sensor, the determined sequence of operations of processes and tracking a storage operation associated with each process. In addition, the method comprises analyzing, by a prediction unit of a security agent, the tracked storage operation of each process to generate a first probabilistic value for each process. The first probabilistic value is the probability of detecting the enumeration stage of attack. In addition, the method comprises determining, by the prediction unit, if the probabilistic value for each process exceeds a first threshold value for a particular process and generating a first verdict value. The first verdict is indicative of a suspicious process if the first probabilistic value for the particular process exceeds the first threshold value. Further, the method comprises conducting, by the analysis module, an advanced analysis of the particular process and generating a second probabilistic value for the particular process. The advanced analysis is at least one of static analysis, dynamic analysis or full stack analysis, wherein advanced analysis depends on the first threshold value. Finally, the method comprises characterizing, by an analysis module, the process as malicious, if the probabilistic value of the second verdict exceeds a second threshold value, and generating a second verdict indicative of the particular process being the malicious process.

In one or more embodiments, the enumeration attack prediction module is configured based on a machine learning module. The machine learning module is trained on a malware dataset. The malware dataset includes at least one of a collection of malicious activities of known attacks and one or more legitimate programs, and collection of events and operations including data markup from various devices. The data markup is indicative of the severity of each query or a combination of queries.

In one or more embodiments, the method further comprises determining, by a cross-process correlator, a correlation between the malicious process and the plurality of processes. The plurality of processes is associated with the malicious process and corresponds to the system event containing the malicious process. The method also includes conducting a full stack analysis of the plurality of processes to determine the second verdict and characterizing one or more processes amongst the associated processes as malicious, if the probabilistic value of the second verdict exceeds the second threshold value.

In one or more embodiments, the method further comprises processing the event containing the malicious process, by the event processing automation unit, based on configured rules, and sending a command to the security sensor to additional data including a collection of the call stack to be analyzed by the analysis module.

In one or more embodiments, the method comprises, upon characterizing at least one process as malicious, rectifying the malicious process by the security sensor. The rectification comprises deletion, quarantining, terminating, and a combination thereof, and restoring the system from the system backup.

In one or more embodiments, the method comprises filtering the storage operations, before being analyzed by the prediction unit, based on at least one type of operation, a type of call, or a list of trusted requests from known processes or services. The filtration is performed by at least one of per-process, per-device, per-storage object, or per-call type criteria.

In one or more embodiments, the method further comprises analyzing storage operation parameters consisting of at least one of the file type, volume, file name or file mask encoded into the storage operation.

In one or more embodiments, the method further includes performing analysis of storage operations in synchronous or asynchronous mode, with or without interrupting the execution of the process code.

The present disclosure also describes a system to predict an enumeration-based attack. The system includes a security sensor configured to track one or more system events, determine a sequence of operations of processes executed in response to the one or more system events, monitor the operations of processes, and track a storage operation associated with a process. In addition, the system includes a security agent having a prediction unit configured to analyze the tracked storage operations of each process to generate a first security verdict and determine if a first probabilistic value identifying the probability of finding the enumeration-based attack exceeds a first threshold value for a particular process. The security agent also includes an analysis module configured to perform advance analysis of the particular process, if the probability exceeds the threshold, generate a second verdict, and characterize the process as a malicious process if the probabilistic value of the second verdict exceeds a second threshold value.

In yet another embodiment, the security agent is configured to perform advanced analysis in response to the first security verdict, when the first probabilistic value exceeds the first threshold. The advanced analysis comprises at least one of static analysis, dynamic analysis or full stack analysis, wherein advanced analysis depends on the first threshold value.

In one or more embodiments, the enumeration-based attack prediction module is configured based on a machine learning module. The machine learning module is trained on a malware dataset, wherein the malware dataset includes at least one of the malicious activities of known attacks and one or more legitimate malware programs and collection of events and operations including data markup from various devices. The data markup is indicative of the severity of each query or a combination of queries.

In one or more embodiments, the system includes an event processing automation unit configured to scan the malicious process and a cross-process correlator configured to determine a correlation between the malicious process and a plurality of processes. The plurality of processes is associated with the malicious process and corresponds to the system event containing the malicious process.

In one or more embodiments, the system includes the analysis module further configured to conduct a full stack analysis of the associated processes to determine the second verdict, and characterize one or more processes amongst the associated processes as malicious, if the probabilistic value of the second verdict exceeds the second threshold value.

In one or more embodiments, the event processing automation unit is further configured to process the event containing the particular process based on configured rules and send a command for a complete analysis of the process to identify the malicious thread. The command is sent to the security sensor, which collects additional data including a collection of the call stack.

In one or more embodiments, the security sensor, upon characterizing at least one process as malicious, is further configured to rectify the malicious process. The rectification comprises at least one of deletion, quarantining, terminating, or a combination thereof, and restoration of the system from a system backup.

In one or more embodiments, the prediction unit is further configured to filter the storage operations, before initiating analysis, based on at least one type of operation, a type of call, or a list of trusted requests from known processes or services. The filtration is performed by at least one of per-process, per-device, per-storage object, or per-call type criteria.

In one or more embodiments, the analysis of storage operations is performed in synchronous or asynchronous mode, and with or without interrupting the execution of the process code, by the prediction unit.

In one or more embodiments, the first verdict is stored in the event store of the security agent.

In one or more embodiments, the full stack is built from a user mode or at the kernel level, based on the mode of operation of the security sensor.

In one or more embodiments, the security sensor is operated in the least one of a user mode, a kernel mode, as a set of injections into controlled applications, or a combination of thereof, wherein the full stack is built based on the mode of operation of the security sensor.

The above summary is not intended to describe each illustrated embodiment or every implementation of the subject matter hereof. The figures and the detailed description that follow more particularly exemplify various embodiments.

### BRIEF DESCRIPTION OF THE DRAWINGS

Subject matter hereof may be more completely understood in consideration of the following detailed description of various embodiments in connection with the accompanying figures, in which:

FIG. 1 is a block diagram of a system for detecting malicious software attacking a device or an environment, in accordance with an embodiment.

FIG. 2 is a block diagram of a prediction unit of the security agent, in accordance with an embodiment.

FIG. 3 is a flowchart of a method for protecting the computing environment, in accordance with an embodiment.

While various embodiments are amenable to various modifications and alternative forms, specifics thereof have been shown by way of example in the drawings and will be described in detail. It should be understood, however, that the intention is not to limit the claimed inventions to the particular embodiments described. On the contrary, the intention is to cover all modifications, equivalents, and alternatives falling within the spirit and scope of the subject matter as defined by the claims.

### DETAILED DESCRIPTION

The present disclosure relates to protecting data stored in the computing environment, such as a virtual machine, a container, or server against a malicious enumeration-based attack.

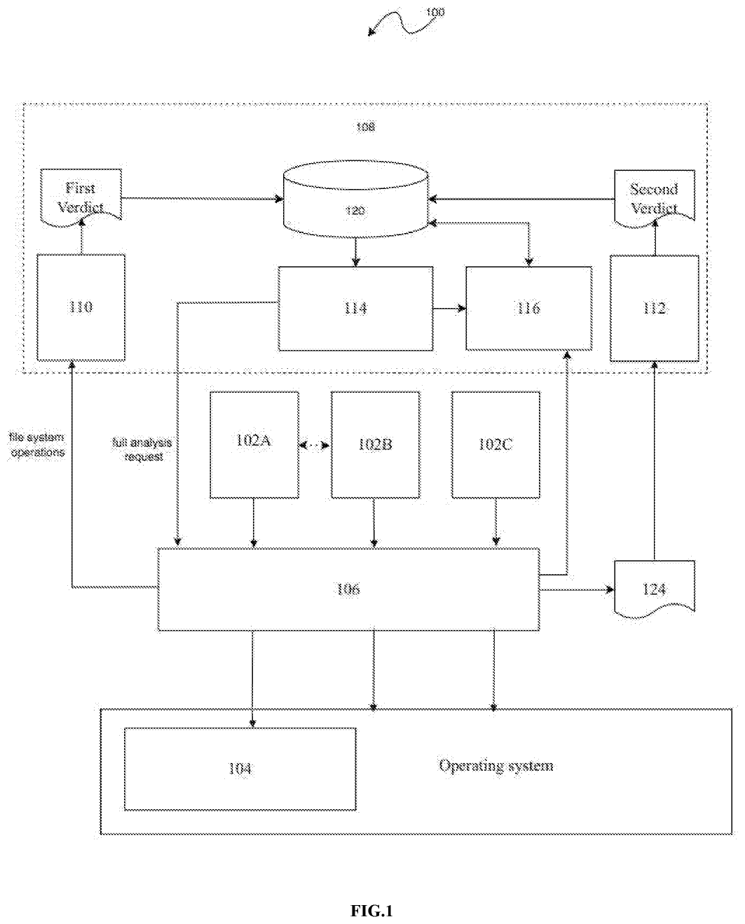

Referring to FIG. 1, a block diagram of a system 100 for detecting malicious software attacking a device or an environment is depicted, in accordance with an embodiment. System 100 is implemented in an environment, such as a virtual machine, server, or personal computer. The system 100 operates in such a way that the system 100 tracks and analyzes all events 102A, 102B, and 102C, occurring in the environment. The events 102A, 102B, and 102C include various events, such as sign-in/sign-out activity, requests to access, read, and write a file stored in a file system 104, and includes interaction between an operating system running the environment.

The system 100 includes various engines, each of which is constructed, programmed, configured, or otherwise adapted, to autonomously carry out a function or set of functions. The term engine as used herein is defined as a real-world device, component, or arrangement of components implemented using hardware, such as by an application specific integrated circuit (ASIC) or field-programmable gate array (FPGA), for example, or as a combination of hardware and software, such as by a microprocessor system and a set of program instructions that adapt the engine to implement the particular functionality, which (while being executed) transform the microprocessor system into a special-purpose device. An engine can also be implemented as a combination of the two, with certain functions facilitated by hardware alone, and other functions facilitated by a combination of hardware and software. In certain implementations, at least a portion, and in some cases, all, of an engine can be executed on the processor(s) of one or more computing platforms that are made up of hardware (e.g., one or more processors, data storage devices such as memory or drive storage, input/output facilities such as network interface devices, video devices, keyboard, mouse or touchscreen devices, etc.) that execute an operating system, system programs, and application programs, while also implementing the engine using multitasking, multithreading, distributed (e.g., cluster, peer-peer, cloud, etc.) processing where appropriate, or other such techniques. Accordingly, each engine can be realized in a variety of physically realizable configurations, and should generally not be limited to any particular implementation exemplified herein, unless such limitations are expressly called out. In addition, an engine can itself be composed of more than one sub-engines, each of which can be regarded as an engine in its own right. Moreover, in the embodiments described herein, each of the various engines corresponds to a defined autonomous functionality; however, it should be understood that in other contemplated embodiments, each functionality can be distributed to more than one engine.

Likewise, in other contemplated embodiments, multiple defined functionalities may be implemented by a single engine that performs those multiple functions, possibly alongside other functions, or distributed differently among a set of engines than specifically illustrated in the examples herein. According to an embodiment, the engine components of the system 100 can be located relatively within a device associated with the system 100, in a singular “cloud” or network, or spread among many clouds or networks. End-user knowledge of the physical location and configuration of components of the system 100 is not required.

The system 100 includes a security sensor 106 and a security agent 108, each having dedicated tasks. The security sensor 106 collects, intercepts, and preprocess system events including storage operations of processes. On the other hand, the security agent 108 stores system event information, analyzes events, and processes verdicts by requesting file static analysis, advanced behavior analysis, file reputation services, full stack collection and performing full stack analysis. In one example, the security sensor 106 can be discrete from the security agent 108 because the security sensor 106 can be implemented as a driver or external component running on the level of BIOS, kernel, user space, or even as a microprogram of the storage controller.

In an embodiment, the security sensor 106 is implemented as a user-mode process, a kernel driver, a set of injections into controlled applications such as user processes, or a combination thereof. Further, the security sensor 106 can track system events. In an embodiment, the security sensor 106 tracks one or more system events and determines a sequence of operations of processes executed associated with the one or more system events. Events in this context represent the system call, API request, function calls, or other operations in the computing environment. For instance, the security sensor 106 tracks or intercepts events at the level of requests to devices, requests to the operating system, and inter-process interactions at the memory level. The security sensor 106 also reads system event logs. One of the types of events that the security sensor 106 monitors is requests to the file system 104, such as I/O requests at the level of working with memory devices within the file system 104.

The security sensor 106 also tracks the sequence of requests to the storage system to check if the sequence of requests is a malicious enumeration. The security sensor 106 captures enumeration requests with particular parameters to the file system. For example, the security sensor 106 detects not only general enumeration requests, but detects enumeration requests of a particular volume, a particular folder having certain documents, system folder(s), and/or enumeration of a particular type of documents using the mask *.doc, *.pdf, *.xls and other formats of documents that are a target of attackers. The security sensor 106 captures requests which correspond to certain files in the computing environment that are attack markers. For instance, the security sensor 106 determines a sequence of operations of processes and tracks a storage operation associated with each process. The security sensor 106 tracks the sequence of processes so that any related process includes or is a malware. Such tracking is useful because the file enumeration is performed by many legitimate processes, so if a threat is detected only by operations with data on the disk, there will be many false positives. Hence, tracking the sequence of processes allows for better detection of malware and root cause analysis. Moreover, the security sensor 106, before sending events for analysis, filters the events by operation or call types or by a list of trusted requests from processes or services. Such operations reduce the usage of unnecessary computational resources while making the analysis quicker, which makes the system 100 fast and efficient.

In one example, the security sensor 106 communicates a signal or a plurality of signals to the security agent 108 to communicate information. Further, the security sensor 106 transmits the information to the security agent 108 either instantaneously when the event has occurred or in a block when a preset number of events have occurred. In either case, the security sensor 106 timely relays the information to the security agent 108.

Further, the security sensor 106 tracks and sends the processes in the form of one or more intercepted transactions for analysis to be performed by the security agent 108. In one example, the intercepted transactions may either be encoded or formatted before passing through the security agent or stored in a raw format in a system memory, wherein the raw format includes binary data.

The security agent 108 is coupled to the security sensor 106 and is configured to receive the information and track one or more system events and a sequence of operations of processes associated with the one or more system events. In one example, the security agent 108 is connected to the security sensor 106 over a network. The network can either be a wired network operating on a BUS interface or a wireless network operating on TCP/IP protocol. The security agent 108 includes various components including, but not limited to, a prediction unit 110, an analysis module 112, an event processing automation unit 114, and a cross-process correlator 116, details of each will be provided in subsequent embodiments.

The prediction unit 110 is configured to perform a preliminary analysis to check if any event and associated process(s) include malicious enumeration and require additional analysis. In other words, the prediction unit 110 is a filter for performing resource-intensive checks, including collecting and analyzing the entire process stack. Such analysis ensures that false positive detections are ruled out and the other components of the security agent 108 are not utilized to analyze the false positive thereby ensuring additional computational resources are not utilized all the time.

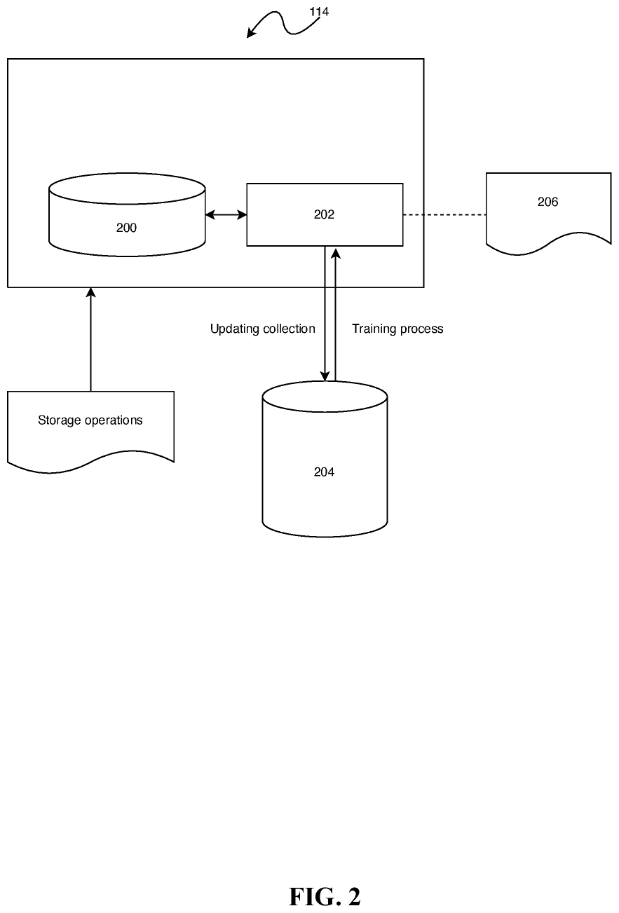

Referring to FIG. 2, a block diagram, the prediction unit 110 is depicted, according to an embodiment of the present disclosure. The prediction unit 110 includes a machine learning (ML) module 200 and an attack predictor 202 operably coupled to the ML module 200. The ML module 200 can be trained using a malware dataset 204 and a preliminary verdict 206. The malware dataset includes one or more types of data. The data can be a collection of malicious activities of known attacks or a collection of one or more legitimate malware programs, or a combination of the malicious activities of known attacks and the collection of the one or more legitimate programs. In addition, the preliminary verdict 206 includes a collection of events and operations including data markup from various devices, such that the data markup is indicative of the severity of each query or a combination of queries. The ML module 200 can also be trained manually by an analyzer who may provide a training dataset.

In one example, the analysis of storage operations is performed in a synchronous mode or an asynchronous mode. In an embodiment, the analysis of storage operations can be performed with or without interrupting the execution of the process code, by the prediction unit 110.

The attack predictor 202 of the prediction unit 110 employs the ML module 200 to analyze the storage operation for each process. Based on the analysis of each process, the attack predictor 202 generates a first probabilistic value for each process. In an embodiment, resulting parameters of the analysis are compared to the parameters related to known malware attacks to identify a degree of similarity between the current process being analyzed and the known malware programs. Thus, the probabilistic value is an indicator of the probability of a process being suspicious. In embodiments, the prediction unit 110 can generate a plurality of probabilistic values for all processes.

Further, the prediction unit 110 can perform an analysis based on various parameters/conditions. For instance, the analysis can be carried out per-process, per-device, per-storage object, and/or per-call type. Based on the analysis, the attack predictor 202 performs additional analysis on the probabilistic values for all the processes. In one example, the attack predictor 202 compares the first probabilistic value for each process with a first threshold value. This comparison process is repeated for each probabilistic value. Further, based on the comparison, the attack predictor 202 of the prediction unit 110 generates a first security verdict. The first security verdict is used to determine if a full stack analysis is needed. In case none of the probabilistic values exceeds the first threshold value, the prediction unit 110 relays the same to the security sensor 106 and determines that further analysis is not needed. On the other hand, if a comparison of a probabilistic value for a particular value exceeds the first threshold value, the first verdict indicates that the process includes or can be a malicious enumeration process. Accordingly, the other components of the security agent 108 are actuated to perform additional analysis.

Additional analysis can include static file analysis of the suspicious process, dynamic analysis using behavior patterns or machine-learning analysis of dynamic or static features of suspicious applications. Dynamic analysis is performed in a computing environment or in a dedicated environment-sandbox, secure virtual machine, and/or emulator. In an embodiment, another additional analysis is a full stack trace analysis. Static, dynamic and stack trace analysis differ from the resource consumption standpoint. So, an additional analysis component in one embodiment is chosen based on the preliminary verdict: if the verdict exceeds a threshold A then the static analysis is performed, if the verdict exceeds a threshold B then dynamic analysis is performed, and if the verdict exceeds a threshold C-full stack trace analysis is performed.

Referring again to FIG. 1, the analysis module 112 is coupled to the event repository 120 and the security sensor 106. In one example, the event processing automation unit 114 processes an event associated with the particular process for which the first verdict indicated a malicious process based on a set of configured rules. The event processing automation unit 114 sends a command to the security sensor 106 for the purpose of conducting a complete analysis of the process to identify the malicious thread. In one example, receipt of the command makes the security sensor 106 collect additional data including a collection of the call stack 124. The full stack 124 is built in a user mode or at the kernel level, depending on the mode of operation of the security sensor 106.

Further, the prediction unit 110 relays the first security verdict to the security sensor 106 and the analysis module 112. In addition, the analysis module 112 receives the full stack 124 from the security sensor 106 for further analysis. In one example, the analysis module 112 obtains the full stack corresponding to the particular process for which the analysis is to be performed. In one example, the full stack 124 corresponds to the preset patterns that correspond to a known malicious program. In one example, the analysis module 112 performs the analysis and generates a second verdict or a final verdict. The second verdict can be another probabilistic value which is indicative of the similarity between the particular program and the present process corresponding to the known malicious program. Thereafter, the analysis module 112 compares the second verdict with a second threshold value.

In case the second verdict is less than the second threshold value, the analysis module 112 determines that the process is a legitimate program. On the other hand, if the second verdict is greater than the second threshold value, the analysis module 112 determines that the process is a malicious program and requires appropriate action and the event that contains the malicious process is deemed a malware event.

In one example, the analysis module 112 transmits the comparison between the second verdict and the second threshold value to the event repository 120. Further, the second verdict can be relayed to the security sensor 106 to conduct appropriate actions. For instance, the security sensor 106, upon characterizing at least one process as malicious, is further configured to rectify the malicious process. In one example, the rectification comprises either deletion, quarantining, terminating, or a combination thereof or restoration of the system from a system backup.

In cases where the malicious activity is distributed, i.e. malicious activity is executed as multiple processes that may or may not be a part of the event. Accordingly, the cross-process correlator 116 is actuated by the event processing automation unit 122. In one example, the cross-process correlator 116 determines a correlation between the malicious process and a plurality of processes. Further, the plurality of processes is associated with the malicious process and corresponds to the system event containing the malicious process. Once the co-relationship is established, the security sensor 106, the prediction unit 110, and the cross-process correlator 116 repeat the aforementioned operations.

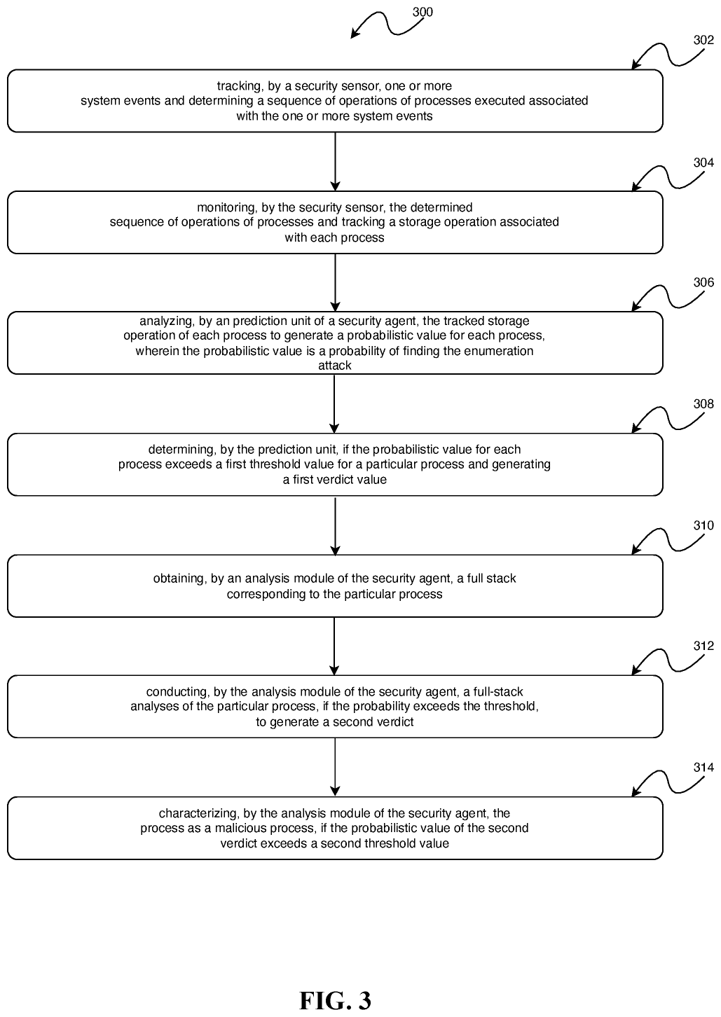

Referring to FIG. 3, a flowchart of a method 300 for protecting a computing environment is depicted, according to an embodiment. More particularly, method 300 depicts operations of threat analysis in a computing environment, such as a virtual machine, a container, and/or an emulator against a malicious enumeration attack, in accordance with an embodiment. The order in which the method 300 is described is not intended to be construed as a limitation, and any number of the described method blocks can be combined in any order to implement the method or similar alternative methods. Additionally, individual blocks can be deleted from the method without departing from the scope of the subject matter described herein. Furthermore, the method can be implemented in any suitable hardware, software, firmware, or combination thereof.

At block 302, the method 300 includes tracking one or more system events and determining a sequence of operations of processes executed associated with the one or more system events.

At block 304, the method 300 includes monitoring, by a security sensor such as security sensor 106, the determined sequence of operations of processes and tracking a storage operation associated with each process.

At block 306, the method 300 includes analyzing the tracked storage operation of each process to generate a probabilistic value for each process, wherein the probabilistic value is a probability of finding an enumeration attack.

At block 308, the method 300 includes determining if the probabilistic value for each process exceeds a first threshold value for a particular process and generating a first verdict value.

At block 310, the method 300 includes obtaining a full stack corresponding to the particular process.

At block 312, the method 300 includes conducting a full-stack analysis of the particular process, if the probability exceeds the threshold, to generate a second verdict.

At block 314, the method 300 includes characterizing the process as malicious, if the probabilistic value of the second verdict exceeds a second threshold value.

1. A method for predicting data threats, the method comprising
tracking, by a security sensor, one or more system events and determining a sequence of operations of processes executed and associated with the one or more system events:
monitoring, by the security sensor, the sequence of operations of processes and a storage operation associated with each process:
analyzing, by a prediction unit of a security agent, the storage operation associated with each process to generate a first probabilistic value for each process, wherein the first probabilistic value is a probability of detecting an enumeration attack:
determining, by the prediction unit, if the first probabilistic value for each process exceeds a first threshold value, and generating a first verdict, wherein the first verdict is indicative of a suspicious process if the probabilistic value for the particular process exceeds the first threshold value:
conducting, by the analysis module of the security agent, advanced analysis of the particular process to generate a second probabilistic value for the particular process; and
characterizing, by the analysis module of the security agent, the particular process as malicious, if the second probabilistic value exceeds a second threshold value, and generating a second verdict indicative of the particular process being the malicious process.

2. The method of claim 1, wherein the prediction unit is configured based on a machine learning module, wherein the machine learning module is trained on:
a malware dataset, wherein the malware dataset includes at least one of: a collection of malicious activities of known attacks and one or more legitimate programs; and
a collection of events and operations including data markup from various devices, wherein the data markup is indicative of a severity of each query or a combination of queries.

3. The method of claim 1, further comprising:
determining, by a cross-process correlator, correlation between the malicious process and a plurality of processes, wherein the plurality of processes is associated with the malicious process and correspond to the one or more system events associated with the malicious process;
conducting a full stack analysis of the plurality of processes to determine the second verdict; and
characterizing one or more processes amongst the associated processes as malicious, if the probabilistic value of the second verdict exceeds the second threshold value.

4. The method of claim 1, wherein the advanced analysis is at least one of static analysis, dynamic analysis, or full stack analysis, wherein the advanced analysis depends on the first threshold value.

5. The method of claim 1, further comprising:
upon characterizing at least one process as malicious, rectifying the malicious process with the security sensor, wherein the rectification comprises at least one of deletion, quarantining, terminating, and restoring the system from a system backup.

6. The method of claim 1, further comprising:
prior to analyzing by the prediction unit, filtering the storage operations based on at least one of a type of operation, a type of call, or a list of trusted requests from known processes or services, wherein the filtering is performed by at least one of per-process, per-device, per-storage object, or per-call type criteria.

7. The method of claim 1, further comprising:
analyzing storage operation parameters including at least one of a file type, a volume, a file name or a file mask encoded into the storage operation.

8. The method of claim 1, further comprising:
performing analysis of storage operations in synchronous or asynchronous mode, with or without interrupting the execution of a process code.

9. A system for predicting an enumeration-based attack comprising:
a security sensor configured to:
track one or more system events and determine a sequence of operations of processes executed in response to the one or more system events;
monitor the operations of processes, and
tracking a storage operation associated with a process;
a security agent operably coupled to the security sensor, including:
a prediction unit configured to:
analyze the tracked storage operations of each process to generate a first security verdict;
determine if a first probabilistic value identifying a probability of finding the enumeration attack exceeds a first threshold value for a particular process; and
an analysis module configured to:
perform an advanced analysis of the particular process, if the first probability value exceeds the first threshold, to generate a second verdict, and
characterize the process as a malicious process, if the probabilistic value of the second verdict exceeds a second threshold value.

10. The system of claim 9, wherein the prediction unit is configured based on a machine learning module, wherein the machine learning module is trained on:
a malware dataset, wherein the malware dataset includes at least one of:
a collection of malicious activities of known attacks,
a collection of one or more legitimate programs, and
a combination of the malicious activities of known attacks and the collection of the one or more legitimate program; and
a collection of events and operations including data markup from various devices, wherein the data markup is indicative of a severity of each query or a combination of queries.

11. The system of claim 9, further comprising:
a cross-process correlator configured to determine a correlation between the malicious process and a plurality of processes, wherein the plurality of processes is associated with the malicious process and corresponds to the system event containing the malicious process.

12. The system of claim 9, wherein the advanced analysis is at least one of static analysis, dynamic analysis or full stack analysis, wherein advanced analysis depends on the first threshold value.

13. The system of claim 12, further comprising:
an event processing automation unit configured to:
process the event containing the particular process based on configured rules; and
send a command for the advanced analysis of the process to identify the malicious thread, wherein the command is sent to the security sensor, which collects additional data including a collection of the call stack.

14. The system of claim 9, wherein the security sensor, upon characterizing at least one process as malicious, is further configured to rectify the malicious process, wherein the rectification comprises at least one of deletion, quarantining, terminating, or a combination thereof, and restoration of the system from a system backup.

15. The system of claim 9, wherein the prediction unit is further configured to filter the storage operations, before initiating analysis, based on at least one of a type of operation, a type of call, or a list of trusted requests from known processes or services, wherein the filtration is performed by at least one of per-process, per-device, per-storage object, or per-call type criteria.

16. The system of claim 9, wherein the security agent is further configured to analyze storage operation parameters consisting of at least one of a file type, a volume, a file name or a file mask encoded into the storage operation.

17. The system of claim 9, wherein analysis of storage operations is performed in synchronous or asynchronous mode, and with or without interrupting the execution of a process code, by the prediction unit.

18. The system of claim 9, wherein the first verdict is stored in an event store of the security agent.

19. The system of claim 12, wherein the full stack is built from a user mode or at the kernel level, based on the mode of operation of the security sensor.

20. The system of claim 9, wherein the security sensor is operated in a least one of a user mode, a kernel mode, as a set of injections into controlled applications, or a combination of thereof.
